(19) United States
(12) Patent Application Publication
(10) Pub. No.: US 2021/0116648 A1
(43) Pub. Date: Apr. 22, 2021

(54) ECCENTRICITY MEASURING APPARATUS

(71) Applicant: SEIKOH GIKEN Co., Ltd., Matsudo-shi, Chiba (JP)

(72) Inventor: Atsushi YAMADA, Matsudo-Shi, Chiba (JP)

(21) Appl. No.: 17/054,524

(22) PCT Filed: Apr. 23, 2020
(86) PCT No.: PCT/JP2020/017452

§ 371 Date: Nov. 11, 2020

(30) Foreign Application Priority Data
Jun. 4, 2019 (JP) 2019-104587

(51) Int. Cl. G02B 6/38; G01B 5/252

(52) U.S. Cl. CPC G02B 6/3834; G01B 5/252; G02B 6/3847

(57) ABSTRACT

A driving force generating unit 27 that generates a driving force; a movable portion 29 that is movable in a crossing direction crossing an axial direction of the ferrule by the driving force of the driving force generating unit; a friction contact portion 31 that is provided on the movable portion to be in contact with an outer periphery of the ferrule, the friction contact portion being configured to rotate the ferrule by a frictional force when the movable portion is moved; and a controller that controls the driving force generating unit are provided, and the controller controls the driving force generating unit to move the movable portion in one direction of the crossing direction for rotating the ferrule by the friction contact portion for measuring the eccentricity, and further move the movable portion to the one direction of the crossing direction for rotating the ferrule by the friction contact portion for adjusting the eccentric direction to the predetermined direction.

### TECHNICAL FIELD

The present invention relates to an eccentricity measuring apparatus for measuring an eccentricity of a ferrule for an optical fiber.

### BACKGROUND ART

When optical fibers are connected with each other, ferrules attached to the end portion of the optical fibers are faced with each other. When the ferrules are faced with each other, the displacement between the cores of the optical fibers is preferred to be reduced for reducing the connection loss.

In the ferrule, the optical fiber is inserted into a center hole. However, the center hole may be eccentric to an outer periphery. In such a case, since the core of the optical fiber is eccentric to the ferrule, it is important to align the eccentric directions of the facing ferrules in order to reduce the displacement between the centers of the cores of the optical fibers.

In this regard, the technology of performing the marking on the outer periphery of the ferrule for indicating an eccentric direction of the center hole is known (e.g., Patent Document 1). In the above described technology, it is possible to match the eccentric directions of the ferrules by aligning the markings.

However, in the above described technology, when performing the marking, the eccentricity is measured while the ferrule is rotated by a roller which is in contact with the outer periphery of the ferrule, and the ferrule is further rotated by the roller in accordance with the eccentricity to adjust the eccentric direction to the predetermined direction.

In this case, a friction contact portion made of a rubber or the like should be prepared on the outer periphery of the roller. However, it is difficult to uniformize the diameter of the friction contact portion from the influence of the deflection and stretch of the friction contact portion. As a result, there is a problem that the preciseness of adjusting the eccentric direction of the ferrule is deteriorated, and the marking may not indicate the eccentric direction of the ferrule correctly.

### PRIOR ART DOCUMENTS

### Patent Documents

[Patent document 1] Japanese Unexamined Patent Application Publication No. H11-305068

### DISCLOSURE OF THE INVENTION

### Problems to be Solved by the Invention

Problems to be Solved are that the preciseness of adjusting the eccentric direction of the ferrule is deteriorated.

### Means for Solving the Problem

The first aspect of the present invention is an eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus having: a driving force generating unit that generates a driving force; a movable portion that is movable in a crossing direction crossing an axial direction of the ferrule by the driving force of the driving force generating unit; a friction contact portion that is provided on the movable portion to be in contact with an outer periphery of the ferrule, the friction contact portion being configured to rotate the ferrule by a frictional force when the movable portion is moved; and a controller that controls the driving force generating unit, wherein the controller controls the driving force generating unit to move the movable portion in one direction of the crossing direction for rotating the ferrule by the friction contact portion for measuring the eccentricity, and after a rotation of the ferrule for measuring the eccentricity is stopped, the controller controls the driving force generating unit to further move the movable portion to the one direction of the crossing direction for rotating the ferrule by the friction contact portion for adjusting the eccentric direction to the predetermined direction.

The second aspect of the present invention is an eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus having: a driving force generating unit that generates a driving force; a movable portion that is movable in a crossing direction crossing an axial direction of the ferrule by the driving force of the driving force generating unit; a friction contact portion that is provided on the movable portion to be in contact with an outer periphery of the ferrule, the friction contact portion being configured to rotate the ferrule by a frictional force when the movable portion is moved; and a controller that controls the driving force generating unit, wherein the controller controls the driving force generating unit to move the movable portion in the crossing direction for rotating the ferrule by the friction contact portion for measuring the eccentricity and rotating the ferrule for adjusting the eccentric direction to the predetermined direction, the movable portion has a support block that is provided along the crossing direction and made of a metal, and the friction contact portion is a rubber material supported by the support block.

### Effects of the Invention

The present invention is hardly influenced by the deflection and stretch of the friction contact portion since the friction contact portion rotates the ferrule when the movable portion moves in the crossing direction crossing the axial direction of the ferrule. Thus, the preciseness of adjusting the eccentric direction of the ferrule can be improved.

Furthermore, in the first aspect of the present invention, the movable portion is moved in one direction for rotating the ferrule for measuring the eccentricity and rotating the ferrule for adjusting the eccentric direction to the predetermined direction. Thus, the eccentric direction can be adjusted to the predetermined direction in a state that a play of the movement of the movable portion is eliminated. Accordingly, the preciseness of adjusting the eccentric direction of the ferrule can be improved more certainly.

### BRIEF DESCRIPTION OF THE DRAWINGS

FIG. 1 is a perspective view schematically showing an eccentricity measuring apparatus concerning an embodiment of the present invention.

FIG. 2 is a perspective view showing a device body of the eccentricity measuring apparatus shown in FIG. 1.

FIG. 3 is a side view schematically showing the device body shown in FIG. 2 together with a marker.

FIG. 4 is a front view showing a ferrule for optical fiber.

FIG. 5 is a plan view showing a rotation mechanism of the device body shown in FIG. 2.

FIG. 6 is a plan view showing the rotation mechanism of the device body shown in FIG. 2.

FIG. 7A and FIG. 7B are front views showing the ferrule and the support block of the movable portion when adjusting the eccentric direction.

### MODES FOR CARRYING OUT THE INVENTION

The purpose of improving the preciseness of adjusting the eccentric direction of the ferrule is achieved by the eccentricity measuring apparatus described below.

The eccentricity measuring apparatus is an eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus having: a driving force generating unit that generates a driving force; a movable portion that is movable in a crossing direction crossing an axial direction of the ferrule by the driving force of the driving force generating unit; a friction contact portion that is provided on the movable portion to be in contact with an outer periphery of the ferrule, the friction contact portion being configured to rotate the ferrule by a frictional force when the movable portion is moved; and a controller that controls the driving force generating unit. The controller controls the driving force generating unit to move the movable portion in one direction of the crossing direction for rotating the ferrule by the friction contact portion for measuring the eccentricity, and after a rotation of the ferrule for measuring the eccentricity is stopped, the controller controls the driving force generating unit to further move the movable portion to the one direction of the crossing direction for rotating the ferrule by the friction contact portion for adjusting the eccentric direction to the predetermined direction.

In addition, the eccentricity measuring apparatus can be an eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus having: a driving force generating unit that generates a driving force; a movable portion that is movable in a crossing direction crossing an axial direction of the ferrule by the driving force of the driving force generating unit; a friction contact portion that is provided on the movable portion to be in contact with an outer periphery of the ferrule, the friction contact portion being configured to rotate the ferrule by a frictional force when the movable portion is moved; and a controller that controls the driving force generating unit, wherein the controller controls the driving force generating unit to move the movable portion in the crossing direction for rotating the ferrule by the friction contact portion for measuring the eccentricity and rotating the ferrule for adjusting the eccentric direction to the predetermined direction, the movable portion has a support block that is provided along the crossing direction and made of a metal, and the friction contact portion is a rubber material supported by the support block.

In addition, the eccentricity measuring apparatus can have a positioning member on which one end of the ferrule in the axial direction is abutted, wherein the crossing direction is inclined to the axial direction to press the one end of the ferrule in the axial direction to the positioning member when the ferrule is rotated by the friction contact portion.

The movable portion can be configured to intersect on the one end of the ferrule in the axial direction.

In addition, the movable portion can have a support block that is provided along the crossing direction, and the friction contact portion can be a rubber material fixed to the support block.

In addition, the eccentricity measuring apparatus can have an elevating portion that raises and lowers the movable portion, wherein the controller controls the elevating portion to lower the movable portion to bring the friction contact portion into contact with the ferrule, and the controller controls the driving force generating unit and the elevating portion to raise the movable portion while the movable portion is moved in the one direction of the crossing direction so that the friction contact portion is separated from the ferrule.

The driving force generating unit can have: an electric motor having a rotor and a stator; a drive screw provided on the rotor of the electric motor; and a driven screw that is formed integrally with the movable portion, screwed to the drive screw, and moved in the crossing direction according to the rotation of the drive screw.

In addition, the eccentricity measuring apparatus can have a marker for performing a marking on a predetermined position of the outer periphery of the ferrule in a circumferential direction of the ferrule after the eccentric direction of the ferrule is adjusted to the predetermined direction.

In the above described configuration, the marking can be configured to be performed on the outer periphery at an opposite side in the axial direction of the ferrule.

After the eccentric direction of the ferrule is adjusted to the predetermined direction, the controller can be configured to make the movable portion be kept lowered and make the friction contact portion be kept in contact with the ferrule so that the marker performs the marking in a state that the friction contact portion is in contact with the ferrule.

### Embodiments

[Configuration of Eccentricity Measuring Apparatus]

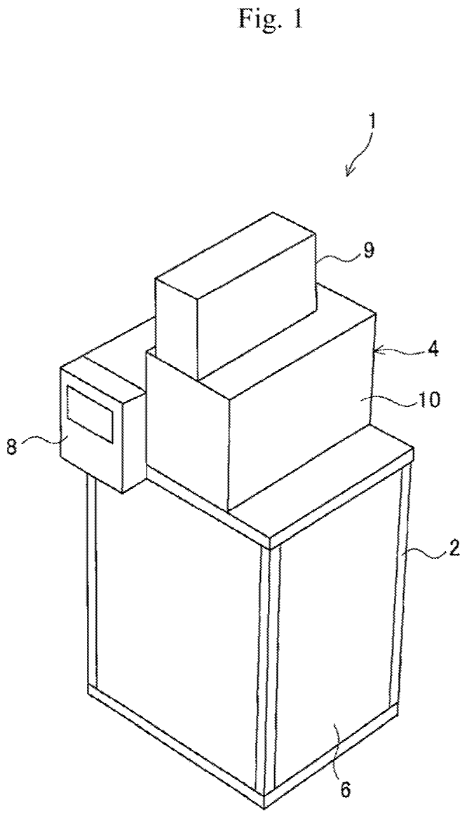

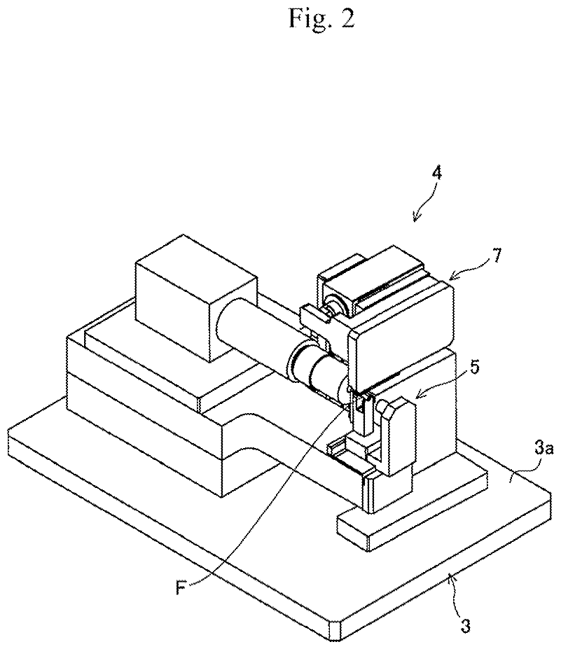

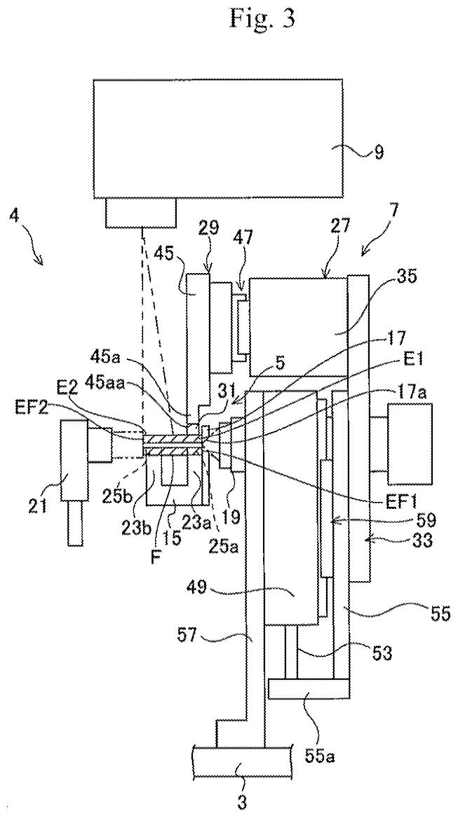

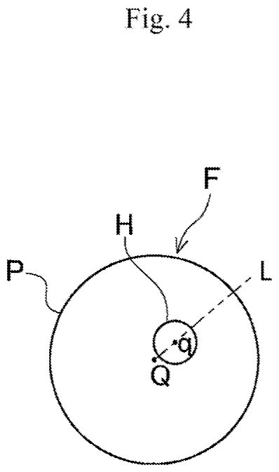

FIG. 1 is a perspective view schematically showing an eccentricity measuring apparatus concerning an embodiment of the present invention. FIG. 2 is a perspective view showing a device body of the eccentricity measuring apparatus shown in FIG. 1. FIG. 3 is a side view schematically showing the device body shown in FIG. 2 together with a marker. FIG. 4 is a front view showing a ferrule for optical fiber.

An eccentricity measuring apparatus 1 is used for measuring an eccentricity of a ferrule F for optical fiber and adjusting an eccentric direction of the ferrule F to a predetermined direction according to the measured eccentricity of the ferrule F. Furthermore, the eccentricity measuring apparatus 1 of the present embodiment is configured to perform a marking on the ferrule F for indicating the eccentric direction.

The ferrule F is a member having a hollow cylindrical shape. The ferrule F has a center hole H into which the optical fiber (not illustrated) is inserted. The eccentricity of the ferrule F means a displacement (eccentricity) between the center Q (hereafter, referred to as an axial center Q) of the outer periphery P of the ferrule F and the center q of the center hole H.

The above described eccentricity measuring apparatus 1 can be used as a part of a continuous machine where a plurality of ferrules F is continuously supplied, the eccentricity of the supplied ferrules F is continuously measured, and the marking is continuously performed. Alternatively, the above described eccentricity measuring apparatus can be used as a stand-alone type machine. However, the eccentricity measuring apparatus 1 is explained as a stand-alone type machine in the present embodiment.

The eccentricity measuring apparatus 1 is configured to have a device body 4, a marker 9, a controller 6 and a user interface 8 on a device frame 2. The device body 4 is housed inside a housing 10 of the device frame 2. The device body 4 has a base 3, an imaging unit 5 and a rotation mechanism 7.

The base 3 is formed by a metal plate, for example. The imaging unit 5, the rotation mechanism 7 and other components are arranged on an upper surface 3a of the base 3. The configuration without having the base 3 can be adopted when the eccentricity measuring apparatus 1 is a part of the continuous machine.

The imaging unit 5 has a ferrule support portion 15, a reference plate 17 which functions as a positioning member, a camera 19 and a light source 21.

The ferrule support portion 15 supports the ferrule F so that the ferrule F can be freely rotated around its axis. The ferrule support portion 15 of the present embodiment has first and second retaining pieces 23a, 23b formed by a V-shaped block made of metal. The ferrule support portion 15 supports the ferrule F so that the ferrule F is bridged on V-shaped support grooves 25a, 25b of the first and second retaining pieces 23a, 23b.

The reference plate 17 is fixed to the ferrule support portion 15 neighboring the first retaining piece 23a. The reference plate 17 is used for positioning the ferrule F by abutting one end E1 (especially an end face EF1) in the axial direction of the ferrule F supported by the first and second retaining pieces 23a, 23b on the reference plate 17. Hereafter, “axial direction” means the axial direction of the ferrule F.

A through hole 17a is formed on the reference plate 17. The diameter of the through hole 17a is smaller than the outer diameter of the ferrule F and larger than the diameter of the center hole H of the ferrule F.

The ferrule support portion 15 can have any shapes as long as it can rotatably support the ferrule F. The shape of the support grooves 25a, 25b is not limited to the V-shape. The support grooves 25a, 25b can be formed in a semicircular shape and a polygonal shape, for example. In addition, the support grooves 25a, 25b are not limited to the grooves directly formed on the block. The support grooves 25a, 25b can be formed by attaching the separately prepared ball or the like to the block.

The camera 19 is arranged to face the end face EF1 of the one end E1 of the ferrule F via the through hole 17a of the reference plate 17. An optical axis of the camera 19 is set to be aligned with the axial center Q of the ferrule F.

The camera 19 is configured to capture an end face image of the center hole H of the ferrule F. The camera 19 is composed of a CMOS camera or a CCD camera, for example. The end face image of the center hole H is an image captured by focusing on an edge portion which is located in the range of 0 to 20 μm from the end face, and is image information of the center hole H at the end face EF1 of the one end E1 of the ferrule F. In the present embodiment, the image information of the light transmitting through the center hole H is captured as the end face image of the center hole H.

The above described camera 19 is connected with the controller 6 to capture (image) the end face image of the center hole H of the ferrule F according to an instruction signal transmitted from the controller 6, and output the captured image to the controller 6. The controller 6 judges (determines) the eccentricity of the ferrule F based on the captured image input to the controller 6. The details of the controller 6 will be described later.

The light source 21 is arranged to face an end face EF2 of the other end E2 of the ferrule F. At the end face EF2, the center hole H of the ferrule F is opened in a tapered state. The light source 21 of the present embodiment is configured to emit light from the end face EF2 of the other end E2 in the axial direction of the ferrule F toward the center hole H. The light source 21 is composed of an LED element or the like. However, other components than the LED element can be used for the light source 21 as long as the light can be transmitted through the center hole H of the ferrule F by emitting light. For example, laser light or the like can be used.

The light source 21 is connected with the controller 6 to emit the light toward the hole of the end face of the ferrule F based on the instruction signal transmitted from the controller 6 for transmitting the light through the center hole H. The transmitted light of the center hole H is made incident in the camera 19 from the center hole H located at the end face EF1 of the one end E1 of the ferrule F. Consequently, the end face image of the center hole H including the transmitted light is captured by the camera 19.

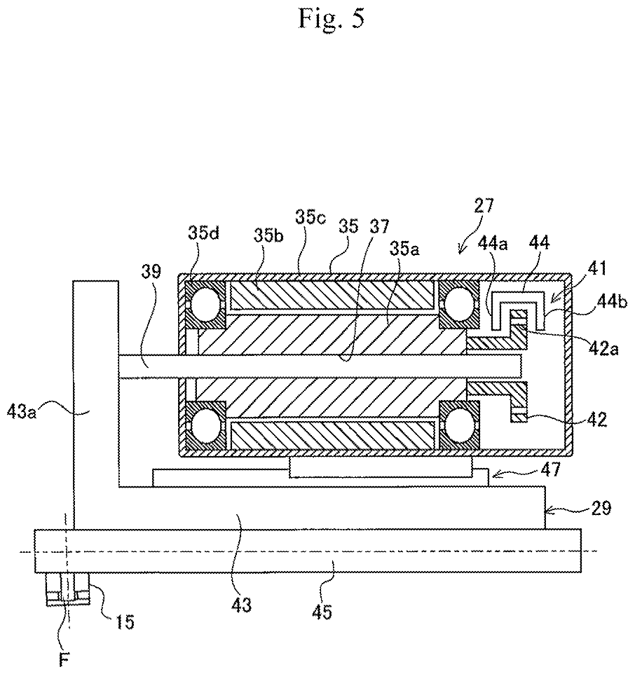

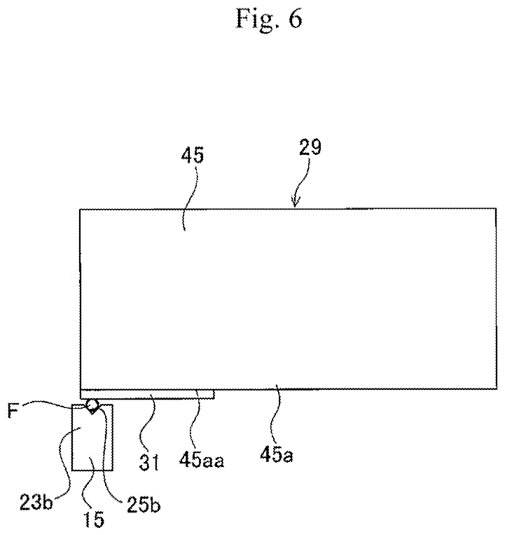

FIG. 5 is a plan view showing the rotation mechanism 7 with a partial cross-section and FIG. 6 is a front view thereof.

As shown in FIG. 3, FIG. 5 and FIG. 6, the rotation mechanism 7 is configured to rotate the ferrule F around its axis while the ferrule F is pressed to the ferrule support portion 15. The rotation mechanism 7 includes a driving force generating unit 27, a movable portion 29, a friction contact portion 31 and an elevating portion 33.

The driving force generating unit 27 is connected with the controller 6 to generate a driving force for rotating the ferrule F based on the instruction signal transmitted from the controller 6. The driving force generating unit 27 of the present embodiment is supported on the base 3 via the later described elevating portion 33. The driving force generating unit 27 includes an electric motor 35, a drive screw 37, a driven screw 39 and an encoder 41. The driving force generating unit 27 can be replaced with other devices such as a linear motor.

The electric motor 35 is arranged along the crossing direction crossed with the axial direction of the ferrule F. Hereafter, “crossing direction” means the crossing direction crossed with the axial direction of the ferrule F. The crossing direction of the present embodiment is set to be inclined to approach to the reference plate 17 in the axial direction toward the forwarding direction of the movement of the movable portion 29.

The electric motor 35 includes a rotor 35a and a stator 35b. The rotor 35a is rotatably supported on a case 35c of the electric motor 35 by a bearing 35d, and the stator 35b is fixed to the case 35c. The drive screw 37 is formed on an inner peripheral surface of the rotor 35a.

The drive screw 37 formed on the inner peripheral surface of the rotor 35a is composed of a nut, and directly rotated by the electric motor 35 around its axis. The driven screw 39 is screwed with the drive screw 37.

The driven screw 39 is composed of a bolt, and moved in the crossing direction along the drive screw 37 in accordance with the rotation of the drive screw 37.

The other side of the driven screw 39 in the crossing direction is located outside the case 35c and connected with the movable portion 29. Therefore, the driven screw 39 is configured to move the movable portion 29 by the movement of the driven screw 39. Accordingly, the movable portion 29 is configured to be movable in the crossing direction by the driving force of the driving force generating unit 27.

The encoder 41 is a detection unit for detecting a rotation angle of the ferrule F. The encoder 41 of the present embodiment includes a disk 42 and a sensor 44. The disk 42 has a plurality of slits 42a in a circumference direction. The disk 42 is attached to the rotor 35a. In the sensor 44, a sensor light emitting unit 44a and a sensor light receiving unit 44b are faced with each other sandwiching the disk 42.

In the above described encoder 41, the disk 42 interrupts the light emitted from the sensor light emitting unit 44a to the sensor light receiving unit 44b of the sensor 44 in accordance with the rotation of the drive screw 37. The pulse information formed by the above described interruption is inputted to the controller 6, and the rotation angle of the ferrule F based on the movement of the movable portion 29 is detected by the controller 6. Instead of the encoder 41, a linear scale for measuring the positions of the movable portion 29 and the driven screw 39 can be used as the detection unit.

The movable portion 29 includes a movable base 43 and a support block 45. Other configurations can be adopted for the movable portion 29 as long as they are movable in the crossing direction with respect to the ferrule F.

The movable base 43 is a plate material made of metal and arranged neighboring the electric motor 35 and along the crossing direction. The movable base 43 is supported to be linearly movable in the crossing direction by a linear guide 47 which is arranged between the electric motor 35 and the movable base 43. One side of the crossing direction of the movable base 43 has a protrusion 43a protruded from the movable base 43 in a plan view. The driven screw 39 is fixed to the protrusion 43a. The support block 45 is attached to the movable base 43.

The support block 45 is provided along the crossing direction and arranged to cross the one end E1 side of the axial direction of the ferrule F. Consequently, the movable portion 29 is configured to cross the one end E1 side of the axial direction of the ferrule F. The support block 45 of the present embodiment is a rectangular plate material made of metal so that the longer side is arranged along the crossing direction and the shorter side is arranged along the vertical direction.

The support block 45 has a support protrusion 45a for supporting the friction contact portion 31. The support protrusion 45a is protruded downward from the support block 45. The support protrusion 45a is formed long in the longitudinal direction along the crossing direction and short in the width direction. The support protrusion 45a relatively forms recess on the support block 45 to prevent the support block 45 from interfering with the reference plate 17. It is not necessary to form the recess on the support block 45 depending on the support position and the shape of the support block 45.

The friction contact portion 31 is provided on the movable portion 29 and in contact with an outer periphery P of the ferrule F to rotate the ferrule F by the frictional force when the movable portion 29 is moved. The friction contact portion 31 of the present embodiment is made of a rubber material fixed to the support block 45. The rubber material here can be a rubber simple substance or composite material. It is enough if at least the surface contacted with the ferrule F is made of rubber. The rubber material of the present embodiment is composite material formed by covering a core body made of resin or the like with a cover rubber. Preferably, the surface friction coefficient of the rubber material is 0.4 or more and the thickness of the rubber material is 1 to 3 mm.

The friction contact portion 31 is formed in a sheet shape or a belt shape and adhered to a lower surface 45aa of the support protrusion 45a of the support block 45, for example. The lower surface 45aa is formed by a flat surface along the crossing direction.

Same as the support protrusion 45a of the support block 45, the friction contact portion 31 is formed long in the longitudinal direction along the crossing direction and short in the width direction. As described above, the friction contact portion 31 is formed in a sheet shape or a belt shape adhered to the support block 45 and long in the longitudinal direction. Thus, the friction contact portion 31 is hardly deformed or bent in the crossing direction.

When the movable portion 29 is moved in one (one direction) of the crossing direction, the friction contact portion 31 of the present embodiment rotates the ferrule F which is in contact with the friction contact portion 31 for measuring the eccentricity and further rotates the ferrule F for adjusting the eccentric direction to the predetermined direction. When the movable portion 29 is moved in one direction of the crossing direction, the forward direction is set to the one end in the crossing direction of the movable portion 29 located at the reference plate 17 side. However, when the movable portion 29 is moved in the crossing direction, the forward direction can be set to the other end in the crossing direction of the movable portion 29. In such a case, the inclination of the crossing direction is reversed.

When the above described ferrule F is rotated, since the crossing direction is inclined (oblique) with respect to the axial direction of the ferrule F, the force acts on the ferrule F in the axial direction for pressing the ferrule F toward the reference plate 17. Therefore, the position of the ferrule F is determined (positioned) by abutting the end face E1 on the reference plate 17.

Accordingly, the crossing direction is configured to be inclined relative to the axial direction so that the one end in the axial direction of the ferrule F is pressed to the reference plate 17 when the ferrule F is rotated by the friction contact portion 31. The crossing direction can be perpendicular to the axial direction of the ferrule F. In such a case, the reference plate 17 can be omitted.

The rotation for measuring the eccentricity is performed by rotating the ferrule F by one rotation. The rotation for adjusting the eccentric direction to the predetermined direction is performed by rotating the ferrule F until the eccentric direction of the ferrule F is aligned with the upper side which is the predetermined direction. The rotation for adjusting the eccentric direction is performed by approximately one rotation at the maximum. In addition, before the rotation for measuring the eccentricity, a preliminary rotation of the ferrule F is performed for making the one end E1 of the ferrule F supported on the ferrule support portion 15 abut on the reference plate 17 for positioning the ferrule F.

Accordingly, the length of the friction contact portion 31 in the crossing direction is preferably approximately at least three times as long as a peripheral length of the ferrule F.

The elevating portion 33 is connected with the controller 6 to elevate (raise/lower) the movable portion 29 based on the instruction signal transmitted from the controller 6. Accordingly, the elevating portion 33 moves (lowers) the movable portion 29 downward so that the friction contact portion 31 is in contact with the ferrule F, and moves (raises) the movable portion 29 upward so that the friction contact portion 31 is apart from the ferrule F.

The elevating portion 33 of the present embodiment is formed similarly with the driving force generating unit 27. The elevating portion 33 has an electric motor 49, a driven screw 53 and an elevating base 55. The elevating portion 33 can be formed by an air cylinder apparatus or the like.

The electric motor 49 is supported on the base 3 of the eccentricity measuring apparatus 1 by a motor support portion 57 along the vertical direction. Same as the electric motor 35, a drive screw (not illustrated) is provided on a rotor (not illustrated) of the electric motor 49 so that the drive screw is concentrically and integrally rotated with the rotor. The driven screw 53 is screwed with the drive screw. The driven screw 53 is located outside the electric motor 49 and provided integrally with the elevating base 55.

The elevating base 55 has a plate shape arranged neighboring the electric motor 49 and along the vertical direction. The elevating base 55 is supported to be movable in the vertical direction by an elevating guide 59 which is arranged between the electric motor 49 and the elevating base 55. A protrusion 55a is provided on one side (lower end) in the vertical direction of the elevating base 55. The driven screw 53 is provided on the protrusion 55a.

The electric motor 35 of the driving force generating unit 27 is supported on the other side (upper end) in the vertical direction of the elevating base 55. Accordingly, the elevating portion 33 is a mechanism for raising/lowering the movable portion 29 via the driving force generating unit 27.

When the movable portion 29 is moved upward, cooperating with the driving force generating unit 27, the elevating portion 33 raise the movable portion 29 while the movable portion 29 is moved to one direction of the crossing direction. Consequently, the friction contact portion 31 is made apart from the ferrule F. When the friction contact portion 31 is formed by a material which is not adhered to the ferrule F, it is not necessary to move the friction contact portion 31 to one direction of the crossing direction when the friction contact portion 31 is made apart from the ferrule F.

The marker 9 is used for performing a marking on a predetermined position of an outer periphery P of the ferrule F in the peripheral direction after the eccentric direction is adjusted to the predetermined direction. Namely, a marking M is performed on the point where a line L which extends in the eccentric direction from the axial center Q of the ferrule F through a center q of the center hole H is crossed with the outer periphery P.

In the present embodiment, the position of the marking M is located on the predetermined position in the peripheral direction and the axial direction of the ferrule F. However, it is enough if the predetermined position, which is the position of the marking M, can indicate the eccentric direction. Thus, the predetermined position especially means the position in the peripheral direction and the predetermined position is not limited by the axial direction of the ferrule F. In addition, the marking M of the present embodiment can be a point or a line, for example. However, the shape of the marking M is not limited.

In addition, the marker 9 is composed of a laser marker. However, the marker 9 can be a marker using an ink or a marker for forming a notch. Furthermore, it is also possible to perform the marking in handwriting without using the marker 9.

The marker 9 of the present embodiment is attached on the housing 10 of the device body 4. Consequently, the marker 9 is arranged above the ferrule F at the other end E2 side which is not crossing with the movable portion 29. As a result, the marker 9 performs the marking on the outer periphery P at the other end E2 side of the ferrule F. The marker 9 can be supported on the base 3 of the device body 4. In addition, the marker 9 can be separately provided with the eccentricity measuring apparatus 1 or the marker 9 can be omitted.

When performing the marking, the friction contact portion 31 is kept in contact with the ferrule F by keeping the movable portion 29 be lowered. Consequently, the marker 9 can perform the marking stably in a state that the friction contact portion 31 is in contact with the ferrule F.

The user interface 8 is a device used for operating the eccentricity measuring apparatus 1 and displaying the status of the eccentricity measuring apparatus 1. The user interface 8 can be composed of a liquid crystal monitor, a keypad, a touch panel, a keyboard and a mouse, for example.

The controller 6 is arranged inside the device frame 2 or separately arranged. The controller 6 is a processor or other computers for executing necessary programs required for control and process components of the eccentricity measuring apparatus 1.

In addition to the function of controlling and processing the components, the controller 6 of the present embodiment has the function of measuring the eccentricity, the function of adjusting the eccentric direction, and the function of performing the marking.

The function of measuring the eccentricity is the function of measuring the eccentric direction and the amount of eccentricity of the ferrule F. Namely, the controller 6 moves the movable portion 29 to one direction to rotate the ferrule F by one rotation and makes the camera 19 of the imaging unit 5 capture the images by each predetermined angle. Then, the controller 6 measures the eccentric direction and the amount of eccentricity of the ferrule F from the rotation trajectory of the center hole H in each angle based on the captured image transmitted from the camera 19. When the measured amount of eccentricity is within a threshold value, the ferrule F is a normal article. When the measured amount of eccentricity exceeds the threshold value, the ferrule F is an abnormal article.

The amount of eccentricity means the length in the radial direction between the axial center Q of the ferrule F and the center q of the center hole H. The eccentric direction means the direction in the radial direction extending from the axial center Q of the ferrule F through the center q of the center hole H.

For rotating the ferrule F by one rotation for measuring the eccentricity, the controller 6 controls energization to the electric motor 35 of the driving force generating unit 27 to rotate the drive screw 37 for moving the movable portion 29 via the driven screw 39. At this time, the controller 6 controls the moving amount of the movable portion 29 in accordance with the pulse information transmitted from the encoder 41 so that the ferrule F is correctly rotated by one rotation and then stopped.

For measuring the eccentricity, the controller 6 preliminarily controls the elevating portion 33 to move the movable portion 29 downward so that the friction contact portion 31 is in contact with the ferrule F.

In addition, the function of adjusting the eccentric direction is the function of adjusting the eccentric direction of the ferrule F to the predetermined direction. Namely, the controller 6 controls energization to the electric motor 35 to further move the movable portion 29 in one direction for adjusting the eccentric direction of the ferrule F to the predetermined direction. Also at this time, the controller 6 controls the moving amount of the movable portion 29 in accordance with the pulse information transmitted from the encoder 41 so that the eccentric direction of the ferrule F is correctly directed to the predetermined direction.

Accordingly, the controller 6 is configured to control the driving force generating unit 27 to move the movable portion 29 in one direction of the crossing direction for rotating the ferrule F by the friction contact portion 31 for measuring the eccentricity, and further move the movable portion 29 in one direction of the crossing direction for rotating the ferrule F by the friction contact portion 31 for adjusting the eccentric direction of the ferrule F to the predetermined direction.

In addition, the marking function is the function of performing the marking on the ferrule F after the eccentric direction of the ferrule F is adjusted to the predetermined direction. Namely, the controller 6 controls the marker 9 to perform the marking on the outer periphery P of the other end E2 side of the ferrule F.

After the eccentric direction of the ferrule F is adjusted to the predetermined direction, the controller 6 of the present embodiment makes the movable portion 29 be kept lowered and makes the friction contact portion 31 be kept in contact with the ferrule F so that the marker 9 performs the marking in a state that the friction contact portion 31 is in contact with the ferrule F.

After the marking is finished, the controller 6 controls the driving force generating unit 27 and the elevating portion 33 to raise the movable portion 29 while the movable portion 29 is moved in one direction of the crossing direction so that the friction contact portion 31 is separated from the ferrule F.

[Measurement of Eccentricity and Marking]

In the eccentricity measuring apparatus 1, the measurement of the eccentricity and the marking of the ferrule F are performed as follows.

First, as shown in FIG. 3, the ferrule F is supported by the support grooves 25a, 25b of the ferrule support portion 15 of the imaging unit 5 so as to be bridged between the first and second retaining pieces 23a, 23b. The ferrule F is supported by conveying the ferrule F from a housing portion of the ferrule F. The ferrule F can be conveyed automatically by a conveyance apparatus or conveyed manually.

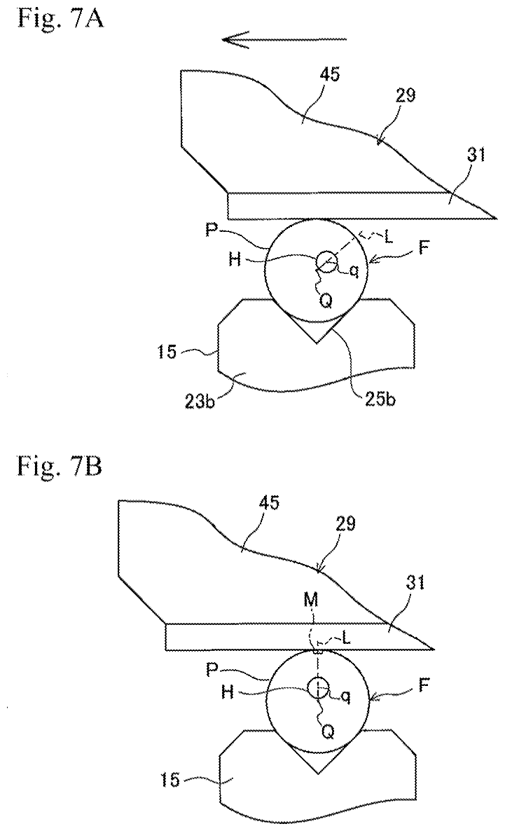

After the ferrule F is supported by the ferrule support portion 15, the controller 6 is automatically or manually instructed to measure the eccentricity. According to the instruction, the movable portion 29 is moved downward by the elevating portion 33 and the friction contact portion 31 is in contact with the outer periphery P of the one end E1 side of the ferrule F (shown in FIG. 7A).

Then, the light source 21 emits light. Specifically, LED is lit. The light source 21 emits light toward the center hole H located at the end face EF2 of the other end E2 of the ferrule F to transmit the light through the center hole H. The light transmitted through the center hole H is directed toward the camera 19 from the center hole H located at the end face EF1 of the one end E1 of the ferrule F.

On the other hand, the movable portion 29 is driven and moved in the crossing direction to rotate the ferrule F around its axis and positions the end face EF1 of the one end E1 of the ferrule F in contact with the reference plate 17.

Since the ferrule F is positioned as described above, the ferrule F is ready to be captured. Thus, the image is captured by inputting a trigger signal to the camera 19. The rotation position of the ferrule F when the image capturing is started is referred to as a capturing start point.

When capturing the image, the end face image of the center hole H including the transmitted light is captured by the camera 19. The image is captured by a trigger mode using the encoder 41. The camera 19 captures the images of the ferrule F by each predetermined angle of rotation of the ferrule F to acquire the end face images of the center hole H. Thus, the improvement of the preciseness is achieved.

The image information captured by the camera 19 is transmitted to the controller 6. After the acquisition of the image information is finished (after the ferrule F is rotated by one rotation), the controller 6 controls to stop the rotation of the ferrule F for measuring the eccentricity of the ferrule F at the same position as the capturing start point. The controller 6 executes the calculation for determining the eccentric direction of the ferrule F.

When determining the eccentric direction, since the ferrule F is rotated by the movement of the movable portion 29 of the rotation mechanism 7 during the capturing performed by the camera 19, the end face images of the center hole H inputted from the camera 19 to the controller 6 are used as the information during the rotation.

Accordingly, if the center hole H of the ferrule F is eccentric, the end face image of the center hole H draws a circular trajectory around the axial center Q of the ferrule F. At this time, the size of the circle of the trajectory increases as the amount of eccentricity increases. Consequently, the amount of eccentricity and the eccentric direction of the center hole H of the ferrule F can be measured. In addition to the amount of eccentricity, the inner diameter of the center hole H can be measured from the end face images of the center hole H including the transmitted light.

When the measured amount of eccentricity exceeds the threshold value, the ferrule F is an abnormal article and removed from the ferrule support portion 15. The ferrule F can be removed automatically by a conveyance apparatus or removed manually.

On the other hand, the amount of eccentricity is within the threshold value, the ferrule F is a normal article and the marking for indicating the eccentric direction is performed on the ferrule F after the eccentric direction of the ferrule F is adjusted.

FIG. 7A and FIG. 7B are front views showing the ferrule F and the support block 45 of the movable portion 29 when adjusting the eccentric direction.

When adjusting the eccentric direction, the movable portion 29 is moved in the crossing direction (arrow direction in FIG. 7A) again to rotate the ferrule F. Consequently, the eccentric direction is directed in the upper direction as the predetermined direction. Thus, the point where the line L located on the eccentric direction of the ferrule F is crossed with the outer periphery P is positioned in the upper direction (FIG. 7B).

In the above described state, the movement of the movable portion 29 is stopped again, and the marking M is formed by the marker 9 on the upper portion (i.e., predetermined direction) in the peripheral direction P of the ferrule F. At this time, the friction contact portion 31 is kept in contact with the ferrule F by keeping the movable portion 29 be lowered. Thus, the marking can be stably and surely performed in a state that the friction contact portion 31 is kept in contact with the ferrule F. Depending on the arrangement of the marker 9, the marking M can be formed on the side (lateral) portion or other portions as the predetermined position.

After the marking M is formed, the movable portion 29 is moved upward and the friction contact portion 31 is separated from the ferrule F. At this time, since the movable portion 29 is raised while being moved in either direction of the crossing direction, the adsorption force or the adhesive force of the friction contact portion 31 to the ferrule F can be reduced by the movement of the movable portion 29 and the friction contact portion 31 can be surely separated from the ferrule F.

### Operations and Effects of Embodiment

The eccentricity measuring apparatus 1 includes: a driving force generating unit 27 that generates a driving force; a movable portion 29 that is movable in the crossing direction crossing the axial direction of the ferrule F by the driving force of the driving force generating unit 27; a friction contact portion 31 that is provided on the movable portion 29 to be in contact with the outer periphery P of the ferrule F, the friction contact portion 31 being configured to rotate the ferrule F by the frictional force when the movable portion 29 is moved; and a controller 6 that controls the driving force generating unit 27.

The controller 6 controls the driving force generating unit 27 to move the movable portion 29 in one direction of the crossing direction for rotating the ferrule F by the friction contact portion 31 for measuring the eccentricity, and further move the movable portion 29 to the one direction of the crossing direction for rotating the ferrule F by the friction contact portion 31 for adjusting the eccentric direction to the predetermined direction.

Accordingly, when the movable portion 29 is moved in the crossing direction crossing the axial direction of the ferrule F, the friction contact portion 31 rotates the ferrule F. Thus, the present embodiment is hardly influenced by the deflection and stretch of the friction contact portion 31, and the preciseness of adjusting the eccentric direction to the predetermined direction can be improved.

Consequently, when the marking is performed on the ferrule F after the eccentric direction is adjusted to the predetermined direction, the eccentric direction of the ferrule F can be correctly indicated by the marking M. Thus, the displacement between the cores of the connected optical fibers can be reduced and the connection loss can be reduced.

In addition, the movable portion 29 is moved in one direction to rotate the ferrule F for measuring the eccentricity and rotate the ferrule F for adjusting the eccentric direction to the predetermined direction in the present embodiment. Thus, the eccentric direction can be adjusted to the predetermined direction in a state that a play of the movement of the movable portion 29 is eliminated, and the preciseness of adjusting the eccentric direction to the predetermined direction can be improved more certainly.

Furthermore, the preliminary rotation the ferrule F is performed before the rotation for measuring the eccentricity in the present embodiment. Thus, the ferrule F can be rotated for measuring the eccentric direction in a state that a play of the movement of the movable portion 29 is eliminated, and the preciseness of adjusting the eccentric direction can be improved more certainly.

Furthermore, the present embodiment includes the reference plate 17 which serves as a positioning member on which one end E1 of the ferrule F in the axial direction is abutted, and the crossing direction is inclined to the axial direction to press the one end E1 of the ferrule F in the axial direction to the reference plate 17 when the ferrule F is rotated by the friction contact portion 31.

Accordingly, the ferrule F can be rotated while the ferrule F is positioned in the axial direction in the present embodiment. Thus, the eccentricity can be measured correctly and the preciseness of adjusting the eccentric direction to the predetermined direction can be improved more certainly.

In the above described configuration of the present embodiment, the movable portion 29 is moved in one direction to rotate the ferrule F for measuring the eccentricity and rotate the ferrule F for adjusting the eccentric direction to the predetermined direction. Thus, the ferrule F can be prevented from moving in the axial direction after the ferrule F is rotated for adjusting the eccentric direction to the predetermined direction.

Consequently, the position of the ferrule F in the axial direction can be kept constant after the eccentric direction is adjusted to the predetermined direction. When the marking is performed on the above described ferrule F, the preciseness of the position of the formed marking M can be improved.

Furthermore, in the present embodiment, the ferrule F is preliminarily rotated to make the one end E1 of the ferrule F abut on the reference plate 17 before the ferrule F is rotated for measuring the eccentricity. Thus, the focal position of the capturing image can be stabilized. Accordingly, the eccentricity can be measured correctly and the preciseness of adjusting the eccentric direction to the predetermined direction can be improved.

In addition, the movable portion 29 intersects on the one end E1 side in the axial direction of the ferrule F in the present embodiment. Thus, the marking can be performed on the outer periphery P of the other end E2 side in the axial direction of the ferrule F.

In particular, since the movable portion 29 is the support block provided along the crossing direction and the friction contact portion 31 is a rubber material fixed to the support block 45, the other end E2 side in the axial direction of the ferrule F can be easily opened for performing the marking.

In addition, the eccentricity measuring apparatus 1 of the present embodiment includes the elevating portion 33 that raises and lowers the movable portion 29, and the controller 6 controls the elevating portion 33 to lower the movable portion 29 to bring the friction contact portion 31 into contact with the ferrule F, and the controller 6 controls the driving force generating unit 27 and the elevating portion 33 to raise the movable portion 29 while the movable portion 29 is moved in one direction of the crossing direction so that the friction contact portion 31 is separated from the ferrule F.

Accordingly, the friction contact portion 31 can be surely separated from the ferrule F while the adsorption force or the adhesive force of the friction contact portion 31 to the ferrule F is reduced by the movement of the movable portion 29. Accordingly, even when the material (e.g., rubber material) originally having high adsorption force and frictional force is used for the friction contact portion 31, the ferrule F can be prevented from adhering with the friction contact portion 31.

The driving force generating unit 27 includes: an electric motor 35 having a rotor 35a and a stator 35b; a drive screw 37 provided on an inner peripheral surface of the rotor 35a; and a driven screw 39 that is formed integrally with the movable portion 29, screwed to the drive screw 37, and moved in the crossing direction according to the rotation of the drive screw 37.

Accordingly, the present embodiment is advantageous in space since the driving force generating unit 27 can be arranged along the crossing direction. In addition, the ferrule F can be correctly and stably rotated by reducing the torque of the electric motor 35 by the drive screw 37 and the driven screw 39 and moving the movable portion 29 in the crossing direction.

In addition, the driving force generating unit 27 has the encoder 41 which can detect the rotation angle of the ferrule F in the present embodiment. Thus, the ferrule F can be correctly rotated for measuring the eccentricity and adjusting the eccentric direction to the predetermined direction. Consequently, the eccentric direction of the ferrule F can be indicated more correctly by the marking M.

The eccentricity measuring apparatus 1 of the present embodiment includes a marker 9 for performing a marking on a predetermined position in the circumferential direction of the outer periphery P of the ferrule F after the eccentric direction of the ferrule F is adjusted to the predetermined direction.

Accordingly, the eccentric direction of the ferrule F can be indicated by the correctly marking it in the present embodiment.

After the eccentric direction of the ferrule F is adjusted to the predetermined direction, the movable portion 29 is kept lowered and makes the friction contact portion 31 be kept in contact with the ferrule F so that the marker 9 performs the marking in a state that the friction contact portion 31 is in contact with the ferrule F.

Accordingly, the marking can be performed stably and surely while keeping the state where the eccentric direction of the ferrule F is adjusted to the predetermined direction.

1. An eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus comprising:
a driving force generating unit that generates a driving force;
a movable portion that is movable in a crossing direction crossing an axial direction of the ferrule by the driving force of the driving force generating unit;
a friction contact portion that is provided on the movable portion to be in contact with an outer periphery of the ferrule, the friction contact portion being configured to rotate the ferrule by a frictional force when the movable portion is moved; and
a controller that controls the driving force generating unit, wherein
the controller controls the driving force generating unit to move the movable portion in one direction of the crossing direction for rotating the ferrule by the friction contact portion for measuring the eccentricity, and
after a rotation of the ferrule for measuring the eccentricity is stopped, the controller controls the driving force generating unit to further move the movable portion to the one direction of the crossing direction for rotating the ferrule by the friction contact portion for adjusting the eccentric direction to the predetermined direction.

2. The eccentricity measuring apparatus according to claim 1, further comprising:
a positioning member on which one end of the ferrule in the axial direction is abutted, wherein
the crossing direction is inclined to the axial direction to press the one end of the ferrule in the axial direction to the positioning member when the ferrule is rotated by the friction contact portion.

3. The eccentricity measuring apparatus according to claim 2, wherein
the movable portion intersects on the one end of the ferrule in the axial direction.

4. An eccentricity measuring apparatus for measuring an eccentricity of a ferrule for optical fiber and adjusting an eccentric direction of the ferrule to a predetermined direction according to the measured eccentricity of the ferrule, the eccentricity measuring apparatus comprising:
a driving force generating unit that generates a driving force;
a movable portion that is movable in a crossing direction crossing an axial direction of the ferrule by the driving force of the driving force generating unit;
a friction contact portion that is provided on the movable portion to be in contact with an outer periphery of the ferrule, the friction contact portion being configured to rotate the ferrule by a frictional force when the movable portion is moved; and
a controller that controls the driving force generating unit, wherein
the controller controls the driving force generating unit to move the movable portion in the crossing direction for rotating the ferrule by the friction contact portion for measuring the eccentricity and rotating the ferrule for adjusting the eccentric direction to the predetermined direction,
the movable portion has a support block that is provided along the crossing direction and made of a metal, and
the friction contact portion is a rubber material supported by the support block.

5. The eccentricity measuring apparatus according to claim 1, further comprising:
an elevating portion that raises and lowers the movable portion, wherein
the controller controls the elevating portion to lower the movable portion to bring the friction contact portion into contact with the ferrule, and
the controller controls the driving force generating unit and the elevating portion to raise the movable portion while the movable portion is moved in the one direction of the crossing direction so that the friction contact portion is separated from the ferrule.

6. The eccentricity measuring apparatus according to claim 1, wherein
the driving force generating unit has:
an electric motor having a rotor and a stator;
a drive screw provided on the rotor of the electric motor; and
a driven screw that is formed integrally with the movable portion, screwed to the drive screw, and moved in the crossing direction according to the rotation of the drive screw.

7. The eccentricity measuring apparatus according to claim 1, further comprising:
a marker for performing a marking on a predetermined position of the outer periphery of the ferrule in a circumferential direction of the ferrule after the eccentric direction of the ferrule is adjusted to the predetermined direction.

8. The eccentricity measuring apparatus according to claim 7, wherein
the marking is performed on the outer periphery at an opposite side in the axial direction of the ferrule.

9. The eccentricity measuring apparatus according to claim 7, wherein
after the eccentric direction of the ferrule is adjusted to the predetermined direction, the controller makes the movable portion be kept lowered and makes the friction contact portion be kept in contact with the ferrule so that the marker performs the marking in a state that the friction contact portion is in contact with the ferrule.

10. The eccentricity measuring apparatus according to claim 1, wherein
the movable portion has a support block that is provided along the crossing direction, and
the friction contact portion is a rubber material fixed to the support block.

11. The eccentricity measuring apparatus according to claim 2, further comprising:
an elevating portion that raises and lowers the movable portion, wherein
the controller controls the elevating portion to lower the movable portion to bring the friction contact portion into contact with the ferrule, and
the controller controls the driving force generating unit and the elevating portion to raise the movable portion while the movable portion is moved in the one direction of the crossing direction so that the friction contact portion is separated from the ferrule.

12. The eccentricity measuring apparatus according to claim 4, further comprising:
an elevating portion that raises and lowers the movable portion, wherein
the controller controls the elevating portion to lower the movable portion to bring the friction contact portion into contact with the ferrule, and
the controller controls the driving force generating unit and the elevating portion to raise the movable portion while the movable portion is moved in the one direction of the crossing direction so that the friction contact portion is separated from the ferrule.

13. The eccentricity measuring apparatus according to claim 2, wherein
the driving force generating unit has:
an electric motor having a rotor and a stator;
a drive screw provided on the rotor of the electric motor; and
a driven screw that is formed integrally with the movable portion, screwed to the drive screw, and moved in the crossing direction according to the rotation of the drive screw.

14. The eccentricity measuring apparatus according to claim 4, wherein
the driving force generating unit has:
an electric motor having a rotor and a stator;
a drive screw provided on the rotor of the electric motor; and
a driven screw that is formed integrally with the movable portion, screwed to the drive screw, and moved in the crossing direction according to the rotation of the drive screw.

15. The eccentricity measuring apparatus according to claim 2, further comprising:
a marker for performing a marking on a predetermined position of the outer periphery of the ferrule in a circumferential direction of the ferrule after the eccentric direction of the ferrule is adjusted to the predetermined direction.

16. The eccentricity measuring apparatus according to claim 4, further comprising:
a marker for performing a marking on a predetermined position of the outer periphery of the ferrule in a circumferential direction of the ferrule after the eccentric direction of the ferrule is adjusted to the predetermined direction.

17. The eccentricity measuring apparatus according to claim 15, wherein
after the eccentric direction of the ferrule is adjusted to the predetermined direction, the controller makes the movable portion be kept lowered and makes the friction contact portion be kept in contact with the ferrule so that the marker performs the marking in a state that the friction contact portion is in contact with the ferrule.

18. The eccentricity measuring apparatus according to claim 16, wherein
after the eccentric direction of the ferrule is adjusted to the predetermined direction, the controller makes the movable portion be kept lowered and makes the friction contact portion be kept in contact with the ferrule so that the marker performs the marking in a state that the friction contact portion is in contact with the ferrule.

19. The eccentricity measuring apparatus according to claim 2, wherein
the movable portion has a support block that is provided along the crossing direction, and
the friction contact portion is a rubber material fixed to the support block.

20. The eccentricity measuring apparatus according to claim 3, wherein
the movable portion has a support block that is provided along the crossing direction, and
the friction contact portion is a rubber material fixed to the support block.
